(19) United States
(12) Patent Application Publication
(10) Pub. No.: US 2024/0012344 A1
(43) Pub. Date: Jan. 11, 2024

(54) TONER, DEVELOPING AGENT, TONER ACCOMMODATING UNIT, IMAGE FORMING APPARATUS, AND IMAGE FORMING METHOD

(71) Applicants: Kohtaroh OGINO, Shizuoka (JP); Yoshitaka YAMAUCHI, Shizuoka (JP); Ayaka MORI, Shizuoka (JP)

(72) Inventors: Kohtaroh OGINO, Shizuoka (JP); Yoshitaka YAMAUCHI, Shizuoka (JP); Ayaka MORI, Shizuoka (JP)

(73) Assignee: Ricoh Company, Ltd., Tokyo (JP)

(21) Appl. No.: 18/347,457

(22) Filed: Jul. 5, 2023

(30) Foreign Application Priority Data
Jul. 7, 2022 (JP) 2022-109663
Apr. 7, 2023 (JP) 2023-062908

(51) Int. Cl. G03G 9/087; G03G 15/08

(52) U.S. Cl. CPC G03G 9/08755; G03G 9/08708; G03G 9/08782; G03G 15/08

(57) ABSTRACT

A toner contains an amorphous polyester resin with an SP value of from 11.0 to 11.5 (cal/cm³)^{1/2}, a styrene resin with an SP value of from 9.5 to 10.5 (cal/cm³)^{1/2}, and a hydrocarbon wax, wherein the molecular weight distribution of the toner soluble in tetrahydrofuran has the main peak between 3,500 to 5,500 as measured by gel permeation chromatography.

### CROSS-REFERENCE TO RELATED APPLICATIONS

This patent application is based on and claims priority pursuant to 35 U.S.C. § 119 to Japanese Patent Application Nos. 2022-109663 and 2023-062908, filed on Jul. 7, 2022 and Apr. 7, 2023, respectively, in the Japan Patent Office, the entire disclosures of which are hereby incorporated by reference herein.

### BACKGROUND

### Technical Field

The present disclosure relates to a toner, a developing agent, a toner accommodating unit, an image forming apparatus, and an image forming method.

### Description of the Related Art

Toners for use in methods including electrophotography, electrostatic recording, and electrostatic printing involve a problem called offset of toner fusing on a member such as a heat roll and belt in an image forming apparatus. To avoid this offset, adding a releasing agent such as hydrocarbon wax to toner is already known.

However, hydrocarbon wax is poorly compatible with a polyester resin with a relatively strong polarity, which is generally used to manufacture toner. This poor compatibility makes it difficult to control dispersion of hydrocarbon wax.

If hydrocarbon wax with an excessively large dispersion diameter is used, the ratio of the hydrocarbon wax present around the surface of toner particles relatively increases. Resultantly, the particles tend to agglomerate, which degrades the toner's flowability. In addition, hydrocarbon wax transfers to carrier particles or an image bearer, causing filming over a long period of use.

Conversely, toners with a hydrocarbon wax with an excessively small dispersion diameter fail to achieve sufficient releasing property.

### SUMMARY

According to embodiments of the present disclosure, a toner is provided which contains an amorphous polyester resin with an SP value of from 11.0 to 11.5 (cal/cm³)^{1/2}, a styrene resin with an SP value of from 9.5 to 10.5 (cal/cm³)^{1/2}, and a hydrocarbon wax, wherein the molecular weight distribution of the toner soluble in tetrahydrofuran has the main peak between 3,500 to 5,500 as measured by gel permeation chromatography.

As another aspect of embodiments of the present disclosure, a developing agent is provided which contains the toner mentioned above.

As another aspect of embodiments of the present disclosure, a toner accommodating unit provided which contains the toner mentioned above.

As another aspect of embodiments of the present disclosure, an image forming apparatus is provided which includes a latent electrostatic image bearer, a latent electrostatic image forming device for forming a latent electrostatic image on the latent electrostatic image bearer, a developing device for developing the latent electrostatic image with a developing agent containing the toner mentioned above, a transfer device configured to transfer the visible image to a printing medium, and a fixing device configured to fix the visible image transferred onto the printing medium.

As another aspect of embodiments of the present disclosure, an image forming method is provided which includes forming a latent electrostatic image on a latent electrostatic image bearer, developing the latent electrostatic image formed on the latent electrostatic image bearer with a developing agent comprising the toner of claim 1 to form a visible image, transferring the visible image to a printing medium, and fixing the visible image on the printing medium.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a schematic diagram illustrating the image forming apparatus according to an embodiment of the present disclosure;

FIG. 2 is a schematic diagram illustrating the image forming apparatus according to another embodiment of the present disclosure;

FIG. 3 is a schematic diagram illustrating an example of the image forming apparatus of each color according to an embodiment of the present disclosure; and

FIG. 4 is a schematic diagram illustrating a process cartridge as the toner accommodating unit according to an embodiment of the present disclosure.

The accompanying drawings are intended to depict example embodiments of the present invention and should not be interpreted to limit the scope thereof. The accompanying drawings are not to be considered as drawn to scale unless explicitly noted. Also, identical or similar reference numerals designate identical or similar components throughout the several views.

### DESCRIPTION OF THE EMBODIMENTS

The terminology used herein is for the purpose of describing particular embodiments only and is not intended to be limiting of the present invention. As used herein, the singular forms “a,” “an,” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Embodiments of the present invention are described in detail below with reference to accompanying drawings. In describing embodiments illustrated in the drawings, specific terminology is employed for the sake of clarity. However, the disclosure of this patent specification is not intended to be limited to the specific terminology so selected, and it is to be understood that each specific element includes all technical equivalents that have a similar function, operate in a similar manner, and achieve a similar result.

For the sake of simplicity, the same reference number will be given to identical constituent elements such as parts and materials having the same functions and redundant descriptions thereof omitted unless otherwise stated.

According to embodiments of the present disclosure, an improved toner is provided that is excellent about filming resistance and releasability.

Toner

The toner of the present disclosure contains an amorphous polyester resin, a styrene resin, a hydrocarbon wax, and preferably a colorant. The toner may contain other optional components.

The toner disclosed in Japanese Unexamined Patent Application Publication No. 2020-187341 contains a saturated polyester resin with a solution parameter (SP) value of from 11.0 to 12.0 (cal/cm³)^{1/2} and a styrene resin with an SP value of 10.6 (cal/cm³)^{1/2}, and a hydrocarbon wax as a releasing agent. This toner does not contain a styrene resin with an SP value of from 9.5 to 10.5 (cal/cm³)^{1/2}. Since this SP value is wide apart from that of the hydrocarbon wax as a releasing agent, the releasing agent does not demonstrate good dispersibility, thereby degrading the toner's filming resistance.

The inventors of the present invention made an investigation and acquired the knowledge that a styrene resin with an SP value of from 9.5 to 10.5 (cal/cm³)^{1/2}, which is not compatible with both a hydrocarbon wax and an amorphous polyester resin, controls dispersibility of the hydrocarbon wax while inhibiting the hydrocarbon wax and the amorphous from being compatible. Thus, a toner containing these components demonstrates excellent about releasability and filming resistance.

The inventors of the present invention also found out that dispersibility of the hydrocarbon wax can be controlled by decreasing the molecular weight of the amorphous polyester resin, which enhances the toner's releasability and filming resistance.

Amorphous Polyester Resin

The amorphous polyester resin mentioned above has an SP value of from 11.0 to 11.5 (cal/cm³)^{1/2} and a molecular weight of from 3,500 to 5,500.

Any polyester resin obtained by polycondensation reaction between a known alcohol and a known acid is suitably used as the amorphous polyester resin.

Examples of the alcohol include, but are not limited to, diols, etherified bisphenols, dialcohol monomers obtained by substituting diols or etherified bisphenols with a saturated or unsaturated hydrocarbon group with 3 to 22 carbon atoms, and tri- or higher alcohol monomers.

Specific examples of the diol include, but are not limited to, ethylene glycol, polyethylene glycol, diethylene glycol, triethylene glycol, 1,2-propylene glycol, 1,3-propylene glycol, 1,4-propylene glycol, neopentyl glycol, and 1,4-butene diol.

Specific examples of the etherified bisphenol include, but are not limited to, 1,4-bis(hydroxymethyl)cyclohexane, bisphenol A, hydrogenated bisphenol A, polyoxyethylenated bisphenol A, polyoxypropylenated bisphenol A, bisphenol A propylene oxide, and bisphenol A ethylene oxide.

Specific examples of the trivalent or higher alcohol monomer include, but are not limited to, sorbitol, 1,2,3,6-hexanetetrol, 1,4-sorbitan, pentaerythritol, dipentaerythritol, tripentaerythritol, sucrose, 1,2,4-butanetriol, 1,2,5-pentanetriol, glycerol, 2-methylpropanetriol, 2-methyl-1,2,4-butanetriol, trimethylolethane, trimethylolpropane, and 1,3,5-trihydroxymethylbenzene.

These can be used alone or in combination.

Examples of the carboxylic acid include, but are not limited to, monocarboxylic acids, divalent organic acid monomers, their anhydrides, dimers of lower alkyl esters and linoleic acid, and trivalent or more polyvalent carboxylic acid monomers.

Specific examples of the monocarboxylic acid include, but are not limited to, palmitic acid, stearic acid, and oleic acid.

Specific examples of the divalent organic acid monomers include, but are not limited to, maleic acid, fumaric acid, mesaconic acid, citraconic acid, terephthalic acid, cyclohexanedicarboxylic acid, succinic acid, adipic acid, sebacic acid, malonic acid, and their substitutes substituted with a saturated or unsaturated hydrocarbon group having 3 to 22 carbon atoms.

Specific examples of the trivalent or higher polyvalent carboxylic acid monomers include, but are not limited to, 1,2,4-benzenetricarboxylic acid, 1,2,5-benzenetricarboxylic acid, 2,5,7-naphthalenetricarboxylic acid, 1,2,4-naphthalenetricarboxylic acid, 1,2,4-butanetricarboxylic acid, 1,2,5-hexanetricarboxylic acid, 1,3-dicarboxyl-2-methyl-2-methylenecarboxypropane, tetra(methylenecarboxyl)methane, 1,2,7,8-octanetetracarboxylic acid (Empol®, trimer acid), and anhydrides of these acids.

These can be used alone or in combination.

The SP value of the amorphous polyester resin is from 11.0 to 11.5 (cal/cm³)^{1/2} and preferably from 11.2 to 11.4 (cal/cm³)^{1/2}. With an SP value of 11.0 (cal/cm³)^{1/2} or greater, the amorphous polyester resin and the styrene resin do not become compatible, achieving excellent filming resistance. An SP value of 11.5 (cal/cm³)^{1/2} or less enhances dispersibility of hydrocarbon wax, which achieves excellent filming resistance.

SP value, the solution parameter δ, is defined by the following relationship in the solution theory of Hildebrand-Scatchard.

δ=(ΔEv/V)^{1/2}

ΔEv means evaporation energy, V represents the volume of molecule, and ΔEv/V means aggregation energy density.

The SP value can be obtained by a method such as the method of Small, et. al, and the method of Fedor, et. al.

The method of Small et. al. is detailed in P. A. Small, J. Appl. Polym, Sci., 3 (1953) 71, for example.

The method of Fedor, et. al. is detailed in a study on additive , “Study on Solubility Parameter of Paint Additive” No. 152, published in October 2010, for example.

The molecular weight of the amorphous polyester resin is from 3,500 to 5,000 and preferably from 4,000 to 4,500. A molecular weight of 3,500 or greater reduces degradation of hot offset resistance caused by the small molecular weight components. A molecular weight of 5,500 or less reduces degradation of wax dispersibility caused by the large molecular weight components.

The molecular weight of the amorphous polyester resin can be obtained from the main peak of the molecular weight distribution of the tetrahydrofuran (THF) soluble portion obtained by gel permeation chromatography (GPC).

Its specific procedures are as follows.

The THF soluble portion and THF insoluble portion of a toner are obtained as follows.

About 1.0 g of a toner is weighed. A total of 50 g of THF is added to dissolve the toner. The solution obtained is subjected to centrifugal followed by filtering at room temperature with filter paper (for chemical analysis) type 5C according to JIS P3801 format. The component in the solution after the filtering is referred to as the THF soluble portion. The residue on the filter paper is determined as the THF insoluble portion.

The molecular weight distribution obtained from the toner's THF soluble portion measured by GPC is measured for the filtrate as a sample solution in the following manner.

The column is stabilized in a heat chamber at 40 degrees C. A total of 50 to 200 μL of the THF sample solution of the resin adjusted to have a concentration of from 0.05 to 0.6 percent by mass was poured into the column while THF as a solvent is allowed to flow through the column at a flow rate of 1 ml per minute. In measuring the molecular weight of the sample toner, the molecular weight distribution of the sample is calculated according to the relationship between the number of counts and the logarithm values of the calibration curve created from several types of the monodispersed polystyrene reference samples. As the standard polystyrene sample for the calibration curve, it is suitable to use at least about ten standard polystyrene samples individually having a molecular weight of 6×10², 2.1×10³, 4×10³, 1.75×10⁴, 5.1×10⁴, 1.1×10⁵, 3.9×10⁵, 8.6×10⁵, 2×10⁶, or 4.48×10⁶, manufactured by TOSOH CORPORATION or Pressure Chemical Co., for example. A refractive index RI detector is used as the detector.

The main peak of the molecular weight distribution of the THF soluble portion obtained is determined as the molecular weight of the amorphous polyester resin. The main peak is the highest peak in the molecular weight distribution.

The proportion of the amorphous polyester resin to a toner is not particularly limited and can be suitably selected to suit to a particular application. It is preferably from 70 to 90 percent by mass and more preferably from 75 to 85 parts by mass.

### Styrene Resin

The styrene resin has an SP value of from 9.5 to 10.5 (cal/cm³)^{1/2}.

The styrene resin has a styrene backbone and is a monopolymer or copolymer containing styrene or a styrene substitute.

Specific examples of the styrene resin include, but are not limited to, polystyrene, chloropolystyrene, poly-α-methylstyrene, a styrene-chlorostyrene copolymer, a styrene-propylene copolymer, a styrene-butadiene copolymer, a styrene-vinyl chloride copolymer, a styrene-vinyl acetate copolymer, a styrene-maleic acid copolymer, a styrene-acrylic ester copolymer (e.g., a styrene-methyl acrylate copolymer, styrene-ethyl acrylate copolymer, styrene-butyl acrylate copolymer, styrene-octyl acrylate copolymer, and styrene-phenyl acrylate copolymer), a styrene-methacrylic ester copolymer (e.g., a styrene-methyl methacrylate copolymer, styrene-ethyl methacrylate copolymer, styrene-butyl methacrylate copolymer, and styrene-phenyl methacrylate copolymer), a styrene-methyl α-chloroacrylate copolymer, a styrene-acrylonitrile-acrylic ester copolymer, and a styrene-α-methylstyrene copolymer.

These can be used alone or in combination. Of these, styrene-α-methylstyrene copolymers are preferable.

Synthetic or procured styrene resins can be used as the styrene resin.

The procured styrene resin is not particularly limited and can be suitably selected to suit to a particular application.

Specific examples include, but are not limited to, FTR-2140 (styrene α-methylstyrene copolymer, SP value of 10.3, manufactured by Mitsui Chemicals, Inc.) and SX100 (styrene resin, SP value of 9.9, manufactured by Yasuhara Chemical Co., Ltd.).

The SP value of the styrene resin is from 9.5 to 10.5 (cal/cm³)^{1/2} and preferably from 9.7 to 10.3 (cal/cm³)^{1/2}. With an SP value of 9.5 (cal/cm³)^{1/2} or greater, the hydrocarbon wax and the styrene resin do not become compatible, achieving excellent filming resistance. An SP value of 10.5 (cal/cm³)^{1/2} or less demonstrates excellent filming resistance because of incompatibility between the amorphous polyester resin and the styrene resin.

The proportion of the styrene resin is not particularly limited and can be suitably selected to suit to a particular application. It is preferably from 3 to 10 percent by mass and more preferably from 4 to 8 percent by mass to a toner.

### Hydrocarbon Wax

This hydrocarbon wax is not particularly limited and can be suitably selected to suit to a particular application as long as it can be used for a typical toner. It includes Fisher-Tropsch wax and ester wax. Of these, Fisher-Tropsch wax is preferable in terms of hot offset resistance.

Synthetic hydrocarbon wax can be used as the hydrocarbon wax. The hydrocarbon wax can also be procured.

The procured styrene resin is not particularly limited and can be suitably selected to suit to a particular application.

Specific examples include, but are not limited to, FNP-0090 (Fisher-Tropsch wax, SP value of 8.37, manufactured by Nihon Seiko Co., LTD.) and WA-05TS (carnauba wax, SP value of 8.8, manufactured by TOA KASEI CO., LTD.).

The SP value of the hydrocarbon wax is from 8.0 to 9.0 (cal/cm³)^{1/2} and preferably from 8.4 to 8.7 (cal/cm³)^{1/2}. With an SP value of 8.0 (cal/cm³)^{1/2} or greater, dispersibility of the hydrocarbon wax increases, achieving excellent offset resistance. An SP value of 9.0 (cal/cm³)^{1/2} or less demonstrates excellent offset resistance because of incompatibility between the hydrocarbon wax and the styrene resin.

The proportion of the hydrocarbon wax is not particularly limited and can be suitably selected to suit to a particular application. It is preferably from 2 to 8 percent by mass and more preferably from 3 to 7 percent by mass to a toner.

### Coloring Material

The colorant for use in the tone of the present disclosure includes conventionally known dyes and pigments such as carbon black, lamp black, iron black, aniline blue, phthalocyanine blue, phthalocyanine green, hansa yellow G, rhodamin 6C lake, calco oil blue, chrome yellow, quinacridone, benzidine yellow, rose bengal, and triarylmethane dyes. These can be used alone or in combination. They can be used as black toner or full color toner.

The proportion of the colorant to the binder resin component of a toner is preferably from 1 to 30 percent by mass and more preferably from 3 to 20 percent by mass.

### Other Components

There is no specific limit to the other components. Any component can be selected to suit to a particular application.

Specific examples include, but are not limited to, resin fine particles, a charge control agent, an external additive, a fluidity improver, a cleanability improver, and a magnetic material.

### Resin Fine Particle

Any resin fine particles can be used as long as the resin can form an aqueous liquid dispersion in an aqueous medium. It can be selected from known resins. Examples include, but are not limited to, thermoplastic resins and thermocuring resins.

Specific examples of the resin of the resin fine particle include, but are not limited to, vinyl resins, polyurethane resins, epoxy resins, polyester resins, polyamide resins, polyimide resins, silicone resins, phenolic resins, melamine resins, urea resins, aniline resins, ionomer resins, and polycarbonate resins. These can be used alone or in combination. Of these resins, at least one of a vinyl resin, polyurethane resin, epoxy resin, and polyester resin is preferably used to readily obtain an aqueous liquid dispersion including fine spherical particles.

Specific examples of the vinyl resins include, but are not limited to, polymers prepared by polymerizing a vinyl monomer or copolymerizing vinyl monomers, such as styrene-(meth)acrylate resins, styrene-butadiene copolymers, (meth)acrylic acid-acrylate copolymers, styrene-acrylonitrile copolymers, styrene-maleic anhydride copolymers, and styrene-(meth)acrylic acid copolymers.

### Charge Control Agent

The charge control agent is not particularly limited and it can be suitably selected to suit to a particular application.

Examples include, but are not limited to, nigrosine dyes, triphenylmethane dyes, chrome containing metal complexes, chelate compounds of molybdic acid, Rhodamine dyes, alkoxyamines, quaternary ammonium salts (including fluorine-modified quaternary ammonium salts), alkylamides, phosphor and compounds including phosphor, tungsten and compounds including tungsten, fluorine-containing activators, metal salts of salicylic acid and metal salts of salicylic acid derivatives.

Specific examples include, but are not limited to, BONTRON 03 (nigrosine dye), BONTRON P-51 (quaternary ammonium salt), BONTRON S-34 (metal-containing azo dye), E-82 (metal complex of oxynaphthoic acid), E-84 (metal complex of salicylic acid), and E-89 (phenolic condensation product), which are manufactured by Orient Chemical Industries Co., Ltd.; TP-302 and TP-415 (molybdenum complex of quaternary ammonium salt), which are manufactured by Hodogaya Chemical Co., Ltd.; LRA-901, and LR-147 (boron complex), which are manufactured by Japan Carlit Co., Ltd.; copper phthalocyanine, perylene, quinacridone, azo pigments and polymers having a functional group such as a sulfonate group, a carboxyl group, and a quaternary ammonium group.

### External Additive

The external additive mentioned above is not particularly limited and can be suitably selected to suit to a particular application.

Specific examples include, but are not limited to, aliphatic acid metal salts such as zinc stearate and aluminum stearate; metal oxides such as titania, alumina, tin oxide, antimony oxide, and titanium oxide; silica; hydrophobic silica; and fluoropolymers. Of these, hydrophobic silica, alumina, titanium dioxide, and titania are preferable.

As the silica and titanium oxide, it is preferable to use hydrophobic silica and hydrophobic titanium obtained by surface-treating the silica and titanium oxide with a fluidity Improver, which is described later.

Specific examples of the silica include, but are not limited to, R972, R974, RX200, RY200, R202, R805, and R812 (all manufactured by Nippon Aerosil Co., Ltd.).

In addition, specific examples of the titania include, but are not limited to, P-25 (manufactured by NIPPON AEROSIL CO., LTD.), STT-30 and STT-65C-S (manufactured by TITAN KOGYO, LTD.), TAF-140 (manufactured by FUJI TITANIUM INDUSTRY CO., LTD.), and MT-150W, MT-500B, MT-600B, and MT-150A (manufactured by TAYCA CORPORATION).

Specific examples of the titanium oxide particulates include, but are not limited to, T-805 (manufactured by NIPPON AEROSIL CO., LTD.); STT-30A and STT-65S-S (manufactured by TITAN KOGYO, LTD.); TAF-500T and TAF-1500T (manufactured by FUJI TITANIUM INDUSTRY CO., LTD.); MT-100S and MT-100T (manufactured by TAYCA CORPORATION); and IT-S (manufactured by ISHIHARA SANGYO KAISHA LTD.).

### Fluidity Improver

The fluidity improver mentioned above is prepared by surface-treating to enhance hydrophobicity and prevents deterioration of fluidity and chargeability even in a high humid environment. The fluidity improver is not particularly limited and can be suitably selected to suit to a particular application.

Specific examples include, but are not limited to, silane coupling agents, silylating agents, silane coupling agents including an alkyl fluoride group, organic titanate coupling agents, aluminum containing coupling agents, silicone oil, and modified silicone oil.

### Cleaning Improver

The cleaning improver is not particularly limited and can be suitably selected to suit to a particular application as long as it is added to the toner in a developing agent to remove the developing agent remaining on an image bearer or a primary intermediate transfer medium after transfer of an image.

Specific examples include, but are not limited to, zinc stearate, calcium stearate, and aliphatic metal salts of stearic acid, polymer fine particles such as polymethyl methacrylate fine particles and polystyrene fine particles, which are prepared by a soap-free emulsion polymerization method. The polymer fine particles preferably have a relatively narrow particle size distribution and the volume average particle diameter thereof is preferably from to 1 μm.

### Magnetic Material

The magnetic material is not particularly limited and can be suitably selected to suit to a particular application.

Specific examples include, but are not limited to iron powder, magnetite, and ferrite. Of these, white materials are preferable in terms of color tone.

### Method of Manufacturing Toner

The method of manufacturing a toner is not particularly limited and can be suitably selected to suit to a particular application. It includes, a mix-kneading/pulverizing method, a dissolution suspension method, and an emulsification aggregation method, for example.

One way of manufacturing a toner by the mix-kneading/pulverizing method is as follows.

A binder resin solution, a pigment dispersion, and a releasing agent liquid dispersion are mixed and preliminarily mixed with a Henschel mixer, followed by melt-kneading at 120 degrees C. with a twin shaft kneader (PCM-30, manufactured by Ikegai Corp.). The melt-kneaded matter obtained was rolled with a roller and cooled down to room temperature with a belt cooler, followed by coarsely pulverizing the rolled kneaded matter to a size of 200 to 300 μm with a hammer mill. Next, the coarsely pulverized matter is finely pulverized with a supersonic pulverizer (LABO JET, manufactured by Nippon Pneumatic Mfg. Co., Ltd.). The finely-pulverized matter is adjusted by classifying with an air-stream classifier (MDS-I, manufactured by Nippon Pneumatic Mfg. Co., Ltd.) to obtain a toner with a weight average particle diameter of 5.8±0.2 μm.

### Developing Agent

The developing agent of the present disclosure contains at least the toner of the present disclosure and other optional components such as a carrier.

The developing agent includes a single component developing agent and a two component developing agent. The two component developing agent is preferable because the two component developing agent enjoys a longer working life when used in a high performance printer supporting an increase in information processing speed.

### Carrier

There is no specific limitation to the carrier and it can be suitably selected to suit to a particular application. As the carrier, a carrier containing a core material and a resin layer covering the core material is preferable.

### Core Material

The core material is not particularly limited and can be suitably selected to suit to a particular application. Examples of the core material include, but are not limited to, highly-magnetized materials such as 50 to 90 emu/g manganese-strontium-based materials, 50 to 90 emu/g manganese-magnesium-based materials, 100 or more emu/g iron powder, and 75 to 120 emu/g magnetite and low-magnetized materials such as 30 to 80 emu/g copper-zinc-based materials. These can be used alone or in combination.

The volume average particle diameter of the core material is not particularly limited and can be suitably selected to suit to a particular application. For example, the core material preferably has a volume average particle diameter of from 10 to 150 μm and more preferably from 40 to 100 μm. A volume average particle diameter of 10 μm or greater can avoid a problem of carrier scattering caused by fine particles increasing in a carrier, thereby decreasing magnetization per particle. A volume average particle diameter of 150 μm or less prevents a problem of toner scattering resulting from a decreased specific surface area, which leads to degrading representation of a solid portion especially in full color printing with a large solid portion.

The toner of the present disclosure mixed with the carrier mentioned above can be used as a developing agent.

### Toner Accommodating Unit

The toner accommodating unit in the present disclosure contains toner in a unit capable of accommodating the toner. Examples of the toner accommodating unit include, but are not limited to, a toner accommodating container, a developing unit, and a process cartridge.

The toner accommodating container is a vessel containing a toner.

The developing unit accommodates toner and develops an image with the toner.

The process cartridge integrally includes at least a latent electrostatic image bearer (also referred to as an image bearer) and a developing device, accommodates toner, and is detachably attachable to an image forming apparatus. The process cartridge may further include at least one member selected from the group consisting of a charger, an exposure, and a cleaning device.

When mounted onto an image forming apparatus, the toner accommodating unit of the present disclosure can form quality images with the toner mentioned above, which has excellent low temperature fixability and high temperature storage stability.

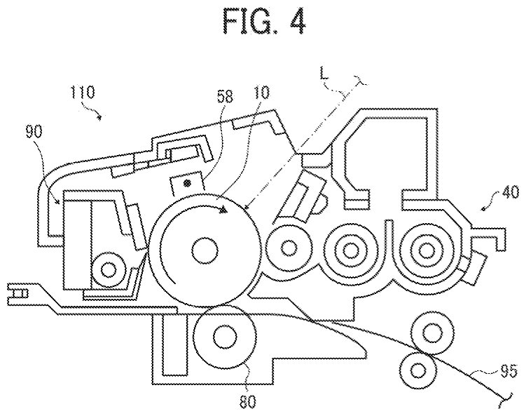

FIG. 4 is a schematic diagram illustrating an example of the process cartridge as the toner accommodating unit of the present disclosure.

A process cartridge 110 illustrated in FIG. 4 includes a drum photoconductor 10, a corona charger 58, a developing device 40, a transfer roller 80, and a cleaner 92. The drum photoconductor 10 is irradiated with an irradiation light L to form a latent electrostatic image on the drum photoconductor 10. The process cartridge 110 of the present disclosure forms an image on a printing medium 95.

Image Forming Apparatus and Image Forming Method

The image forming apparatus of the present disclosure includes a latent electrostatic image bearer, a latent electrostatic image forming device, a development device, and other optional devices.

The image forming method of the present disclosure includes forming a latent electrostatic image, developing the latent electrostatic image, and other optional processes.

The image forming method can be suitably conducted by the image forming apparatus. The latent electrostatic image can be suitably formed with the latent electrostatic image forming device. The latent electrostatic image can be suitably developed with the developing device. The other optional processes can be suitably conducted by the corresponding other optional devices.

The image forming apparatus of the present disclosure preferably includes a latent electrostatic image bearer, a latent electrostatic image forming device for forming a latent electrostatic image on the latent electrostatic image bearer, a developing device for developing the latent electrostatic image on the latent electrostatic image bearer with toner to form a toner image, a transfer device for transferring the toner image onto the surface of a printing medium, and a fixing device for fixing the toner image on the surface of the printing medium.

The image forming method preferably includes forming a latent electrostatic image on a latent electrostatic image bearer, developing the latent electrostatic image formed on the latent electrostatic image bearer with toner to form a toner image, transferring the toner image formed on the latent electrostatic image bearer to the surface of a printing medium, and fixing the toner image transferred to the surface of the printing medium.

The developing device and the developing preferably use the toner of the present disclosure and the developing agent of the present disclosure.

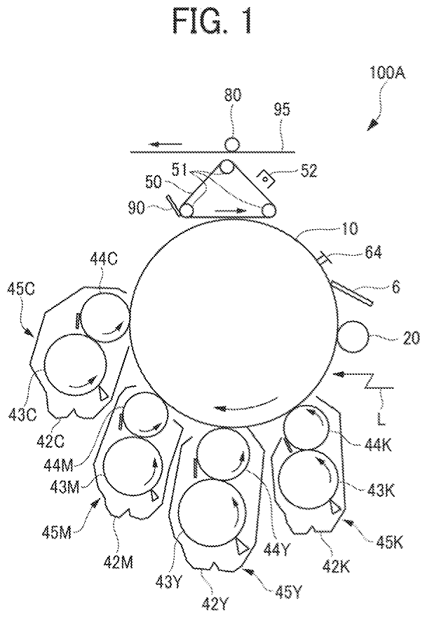

Next, an embodiment of forming images with the image forming apparatus of the present disclosure is described with reference to FIG. 1. An image forming apparatus 100A illustrated in FIG. 1 includes the drum photoconductor 10 as a latent electrostatic image bearer, a roller charger 20 as a charging device, an irradiator, a developing device 45 (K, Y, M, C) as a developing device, an intermediate transfer body 50, a cleaner 6 with a cleaning blade as a cleaning device, and a discharging lamp 64 as a discharging device (quencher).

The intermediate transfer body 50 is an endless belt stretched over three rollers 51 disposed inside and moves in the direction indicated by an arrow in FIG. 1. The three rollers 51 partially serves as transfer bias rollers to apply a transfer bias (primary transfer bias) to the intermediate transfer body 50.

Around the intermediate transfer body 50 is disposed a cleaner 90 including a cleaning blade. Furthermore, a transfer roller 80 capable of applying a transfer bias (secondary transfer bias) to transfer the toner image to a printing medium 95 is disposed facing the intermediate transfer body 50.

Around the intermediate transfer body 50, a corona charger 52 for applying charges to the toner image on the intermediate transfer body 50 is disposed between the contact portion of the drum photoconductor 10 and the intermediate transfer body 50 and the contact portion between the intermediate transfer body 50 and the printing medium 95.

The developing device 45 of each color of black (K), yellow (Y), magenta (M), and cyan (C) includes a developing agent accommodating unit 42 (K, Y, M, C), a developing agent supplying roller 43, and a developing roller 44.

The image forming apparatus 100A uniformly charges the drum photoconductor 10 with the roller charger 20 and then irradiates the drum photoconductor 10 with the irradiation light L to form a latent electrostatic image thereon. Next, the developing device 45 supplies the developing agent to the latent electrostatic image on the drum photoconductor 10 and develops the latent electrostatic image to obtain a toner image. Thereafter, the roller 51 applies a transfer bias to the toner image to primarily transfer it to the intermediate transfer body 50. Then the corona charger 52 applies charges to the toner image on the intermediate transfer body to secondarily transfer it onto the printing medium 95. The toner remaining on the drum photoconductor 10 is removed with the cleaner 6. The discharging lamp 64 discharges the drum photoconductor 10 once.

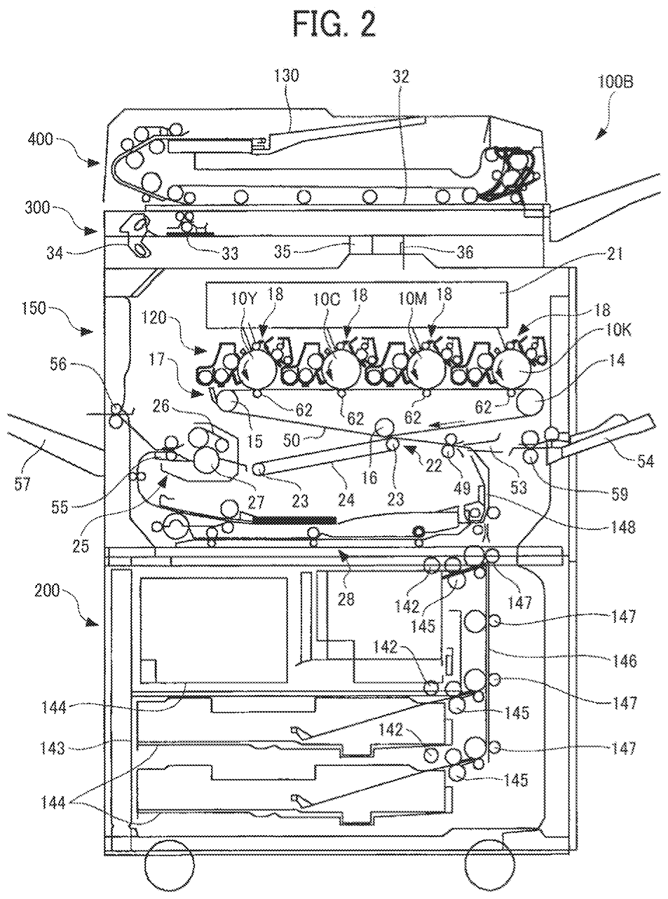

FIG. 2 is a diagram illustrating another example of the image forming apparatus of the present disclosure. An image forming apparatus 100B is a tandem color image forming apparatus including a photocopying unit 150, a sheet feeder table 200, a scanner 300, and an automatic document feeder (ADF) 400.

The photocopying unit 150 of the image forming apparatus has an intermediate transfer body 50 with an endless belt disposed at the center thereof. The intermediate transfer body is stretched over supporting rollers 14, 15, and 16 and rotates in the direction indicated by an arrow.

Around the supporting roller 15, the cleaner 17 is disposed to remove residual toner on the intermediate transfer body 50. A tandem developing device 120, which has four of image forming units 18 for yellow, cyan, magenta, and black, is disposed facing the intermediate transfer body 50 stretched over the supporting rollers 14 and 15 along the transfer direction thereof.

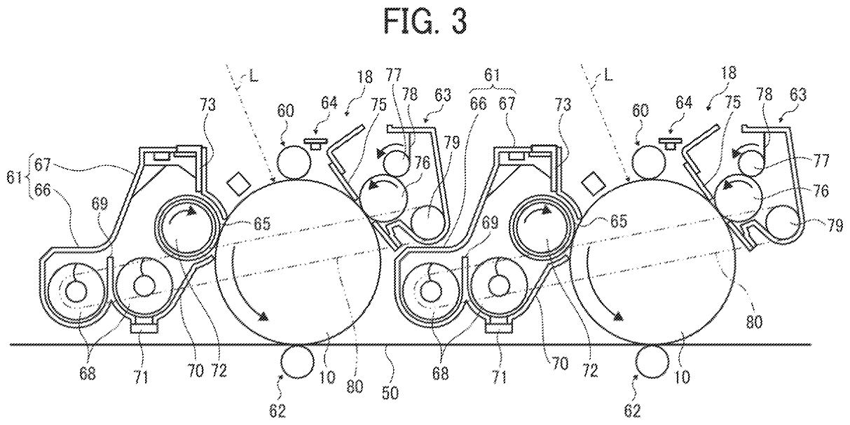

As illustrated in FIG. 3, each image forming unit 18 for each color includes the drum photoconductor 10, the roller charger 60 that uniformly charges the drum photoconductor 10, a developing device 70 that forms each color toner image by developing each color latent electrostatic image of black K, yellow Y, magenta M, and cyan C with each color developing agent, a transfer roller 62 that transfers each color toner image to the intermediate transfer body a cleaner 63, and the discharging lamp 64.

Around the tandem developing device 120 in the image forming apparatus illustrated in FIG. 2, an irradiator 21 is disposed. The irradiator irradiates the drum photoconductor 10 with irradiation light to form a latent electrostatic image.

A secondary transfer device 22 is disposed on the opposite side of the tandem developing device 120 relative to the intermediate transfer body 50. The secondary transfer device 22 includes the secondary transfer belt 24 as an endless belt stretched over a pair of rollers 23. The printing medium transferred on the secondary transfer belt 24 can be brought into contact with the intermediate transfer body 50.

A fixing device 25 is disposed near the secondary transfer device 22. The fixing device 25 includes a fixing belt 26 with an endless belt and a pressing roller 27 pressed against the fixing belt 26.

Furthermore, around the secondary transfer device 22 and the fixing device 25, a reversing device 28 is disposed to reverse the printing medium to form images on both sides of the printing medium.

Next, how a full color image is formed with the image forming apparatus 100B is described. First, an original is set on a document table 130 in the automatic document feeder 400. Alternatively, the automatic document feeder 400 is opened to set an original on a contact glass 32 for the scanner 300, and then the automatic document feeder 400 is closed. When the start button is pressed, the scanner 300 is immediately driven to scan the original on the contact glass 32 with a first scanning unit 33 and a second scanning unit 34 in the case where the original is set on the contact glass 32.

On the other hand, the scanner 300 is driven after the original is moved to the contact glass 32 in the case in which the original is set on the automatic document feeder 400. Then the original is irradiated with light emitted from a light source from the first scanning unit 33 and the reflection light from the original is redirected at the mirror of the second scanning unit 34. The redirected light at the mirror of the second scanning unit 34 passes through an image focusing lens 35 and is received at a reading sensor 36. The color original, color image, is thus read and each color image information on each of black, yellow, magenta, and cyan image is obtained.

Based on each color image information obtained by irradiation from the irradiator, each color latent electrostatic image is formed on the drum photoconductor 10. Each color latent electrostatic image is developed with a developing agent supplied from each tandem developing device 120 to form each color toner image. Each color toner image is sequentially overlapped (primarily transferred) on the intermediate transfer body 50 rotated by the supporting rollers 14, 15, and 16 to form a complex toner image on the intermediate transfer body 50.

In the sheet feeder table 200, one of the sheet feeder rollers 142 is selectively rotated to bring up printing media (sheets) from one of multiple sheet cassettes 144 stacked in a sheet bank 143. A separating roller 145 separates the printing media one by one to feed it to a sheet path 146. Transfer rollers 147 transfer and guide the printing medium to a sheet path 148 in the photocopying unit 150 of the image forming apparatus 100B and the printing medium is held at a registration roller 49. Alternatively, the printing media on bypass tray 54 are brought up and separated one by one with a separating roller 59 into a manual sheet path 53, and also halted at the registration roller 49. The registration roller 49 is generally grounded but a bias can be applied thereto to remove paper dust on the printing medium.

The registration roller 49 is rotated in synchronization with the complex toner image (color transfer image) on the intermediate transfer body 50 to send the printing medium between the intermediate transfer body 50 and the secondary transfer device 22 followed by secondarily transferring the complex toner image to the printing medium.

The printing medium to which the complex toner image is transferred is conveyed on the secondary transfer device 22 to the fixing device 25. The fixing device 25 applies heat and pressure to the complex toner image with a fixing belt 26 and a pressing roller 27 to fix the complex toner image. Thereafter, the printing medium is directed at a switching claw 55 to an ejection roller 56, which ejects the printing medium to stack it on an ejection tray 57. Alternatively, the printing medium is switched at the switching claw 55 to the reversing device 28, which guides the printing medium to the transfer position again. Then an image is formed on the other side of the printing medium and ejected to the ejection roller 56 to stack it on the ejection tray 57.

The cleaner 17 removes the toner remaining on the intermediate transfer body 50 after the complex toner image is transferred.

The terms of image forming, recording, and printing in the present disclosure represent the same meaning.

Also, recording media, media, and print substrates in the present disclosure have the same meaning unless otherwise specified.

Having generally described preferred embodiments of this disclosure, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

Next, the present disclosure is described in detail with reference to Examples but not limited thereto.

### Synthesis Example 1 of Amorphous Polyester Resin

Amorphous polyester resin A was obtained in the following manner.

A total of 18 mol of an adduct of bisphenol A with 1 mol of propylene oxide, 100 mol of terephthalic acid, and 102 mol of bisphenol A with 1 mol of ethylene oxide were placed in a four-necked flask equipped with a nitrogen introducing tube, a dehydration tube, a stirrer, and a thermocouple and allowed to react with titanium tetraisopropoxide (500 ppm to the resin portion) at normal pressure at 230 degrees C. for 8 hours, followed by a four-hour reaction under a reduced pressure of from 10 to 15 mm Hg. Then terephthalic acid anhydride was added to the flask to achieve a proportion of 1 mol percent to all the resin components followed by a three-hour reaction at 180 degrees C. The amorphous polyester resin A obtained was measured to have an SP value of 11.3 (cal/cm³)^{1/2}. In addition, the molecular weight of the amorphous polyester resin A obtained was measured, which was 4,500. The SP values and molecular weights are shown in Table 1.

### Method of Measuring Molecular Weight of Amorphous Polyester Resin

The molecular weight of the amorphous polyester resin was obtained from the main peak of the molecular weight distribution of the tetrahydrofuran (THF) soluble portion measured by gel permeation chromatography (GPC).

First, the THF soluble portion and THF insoluble portion of a toner were obtained as follows.

About 1.0 g of a toner was weighed. A total of 50 g of THF was added to dissolve the toner. The solution obtained was subjected to centrifugal followed by filtering at room temperature with filter paper (for chemical analysis) type 5C according to JIS P3801 format. The component in the solution after the filtering was referred to as the THF soluble portion. The residue on the filter paper was determined as the THF insoluble portion.

The molecular weight distribution obtained from the toner's THF soluble portion by GPC for the filtrate as a sample solution was measured as follows.

The column was stabilized in a heat chamber at 40 degrees C. A total of 50 to 200 μL of the THF sample solution adjusted to have a concentration of from 0.05 to 0.6 percent by mass was poured into the column while THF as a solvent was allowed to flow through the column at a flow rate of 1 ml per minute. In measuring the molecular weight of the sample toner, the molecular weight distribution of the sample was calculated according to the relationship between the number of counts and the logarithm values of the calibration curve created from several types of the monodispersed polystyrene reference samples. As the standard polystyrene sample for the calibration curve, at least about ten standard polystyrene samples individually having a molecular weight of 6×10², 2.1×10³, 4×10³, 1.75×10⁴, 5.1×10⁴, 1.1×10⁵, 3.9×10⁵, 8.6×10⁵, 2×10⁶ , or 4.48×10⁶, manufactured by TOSOH CORPORATION or Pressure Chemical Co. were used. A refractive index (RI) detector was used as the detector.

The main peak of the molecular weight distribution of the THF soluble portion obtained was determined as the molecular weight of the amorphous polyester resin. The main peak is the highest peak in the molecular weight distribution.

### Synthesis Example 2 of Amorphous Polyester Resin

Amorphous polyester resin B was obtained as follows. A total of 18 mol of an adduct of bisphenol A with 1 mol of propylene oxide, 105 mol of terephthalic acid, and 102 mol of bisphenol A with 1 mol of ethylene oxide were placed in a four-necked flask equipped with a nitrogen introducing tube, a dehydration tube, a stirrer, and a thermocouple and allowed to react with titanium tetraisopropoxide (500 ppm to the resin portion) at normal pressure at 230 degrees C. for 8 hours, followed by a four-hour reaction under a reduced pressure of from 10 to 15 mm Hg. Then terephthalic acid anhydride was added to the flask to achieve a proportion of 1 mol percent to all the resin components followed by a three-hour reaction at 180 degrees C. The amorphous polyester resin B obtained was measured in the same manner as in Synthesis Example 1. The SP value was 11.4 (cal/cm³)^{1/2}. In addition, the molecular weight of the amorphous polyester resin B obtained was measured in the same manner as in Synthesis Example 1, which was 5,500. The SP values and molecular weights are shown in Table 1.

### Synthesis Example 3 of Amorphous Polyester Resin

Amorphous polyester resin C was obtained as follows. A total of 55 mol of ethylene glycol, 5 mol of an adduct of bisphenol A with 1 mol of propylene oxide, 100 mol of terephthalic acid, and 60 mol of bisphenol A with 1 mol of ethylene oxide were placed in a four-necked flask equipped with a nitrogen introducing tube, a dehydration tube, a stirrer, and a thermocouple and allowed to react with titanium tetraisopropoxide (500 ppm to the resin portion) at normal pressure at 230 degrees C. for 8 hours, followed by a four-hour reaction under a reduced pressure of from 10 to 15 mm Hg. Then terephthalic acid anhydride was added to the flask to achieve a proportion of 1 mol percent to all the resin components followed by a three-hour reaction at 180 degrees C. The amorphous polyester resin C obtained was measured in the same manner as in Synthesis Example 1. The SP value was 11.6 (cal/cm³)^{1/2}. In addition, the molecular weight of the amorphous polyester resin C obtained was measured in the same manner as in Synthesis Example 1, which was 4,500. The SP values and molecular weights are shown in Table 1.

### Synthesis Example 4 of Amorphous Polyester Resin

Amorphous polyester resin D was obtained as follows. A total of 18 mol of an adduct of bisphenol A with 1 mol of propylene oxide, 100 mol of terephthalic acid, and 102 mol of bisphenol A with 2 mol of ethylene oxide were placed in a four-necked flask equipped with a nitrogen introducing tube, a dehydration tube, a stirrer, and a thermocouple and allowed to react with titanium tetraisopropoxide (500 ppm to the resin portion) at normal pressure at 230 degrees C. for 8 hours, followed by a four-hour reaction under a reduced pressure of from 10 to 15 mm Hg. Then terephthalic acid anhydride was added to the flask to achieve a proportion of 1 mol percent to all the resin components followed by a three-hour reaction at 180 degrees C. The amorphous polyester resin D obtained was measured in the same manner as in Synthesis Example 1. The SP value was 10.4 (cal/cm³)^{1/2}. In addition, the molecular weight of the amorphous polyester resin D obtained was measured in the same manner as in Synthesis Example 1, which was 4,500. The SP values and molecular weights are shown in Table 1.

### Synthesis Example 5 of Amorphous Polyester Resin

Amorphous polyester resin E was obtained as follows. A total of 23 mol of an adduct of bisphenol A with 1 mol of propylene oxide, 100 mol of terephthalic acid, and 107 mol of bisphenol A with 1 mol of ethylene oxide were placed in a four-necked flask equipped with a nitrogen introducing tube, a dehydration tube, a stirrer, and a thermocouple and allowed to react with titanium tetraisopropoxide (500 ppm to the resin portion) at normal pressure at 230 degrees C. for 8 hours, followed by a four-hour reaction under a reduced pressure of from 10 to 15 mm Hg. Then terephthalic acid anhydride was added to the flask to achieve a proportion of 1 mol percent to all the resin components followed by a three-hour reaction at 180 degrees C. The amorphous polyester resin E obtained was measured in the same manner as in Synthesis Example 1. The SP value was 11.27 (cal/cm³)^{1/2}. In addition, the molecular weight of the amorphous polyester resin E obtained was measured in the same manner as in Synthesis Example 1, which was 3,000. The SP values and molecular weights are shown in Table 1.

### Synthesis Example 6 of Amorphous Polyester Resin

Amorphous polyester resin F was obtained as follows. A total of 13 mol of an adduct of bisphenol A with 1 mol of propylene oxide, 100 mol of terephthalic acid, and 97 mol of bisphenol A with 1 mol of ethylene oxide were placed in a four-necked flask equipped with a nitrogen introducing tube, a dehydration tube, a stirrer, and a thermocouple and allowed to react with titanium tetraisopropoxide (500 ppm to the resin portion) at normal pressure at 230 degrees C. for 8 hours, followed by a four-hour reaction under a reduced pressure of from 10 to 15 mm Hg. Then terephthalic acid anhydride was added to the flask to achieve a proportion of 1 mol percent to all the resin components followed by a three-hour reaction at 180 degrees C. The amorphous polyester resin F obtained was measured in the same manner as in Synthesis Example 1. The SP value was 11.38 (cal/cm³)^{1/2}. In addition, the molecular weight of the amorphous polyester resin F obtained was measured in the same manner as in Synthesis Example 1, which was 6,500. The SP values and molecular weights are shown in Table 1.

TABLE 1

| | | Amorphous polyester resin | | | | | |
|---|---|---|---|---|---|---|---|
| | | A | B | C | D | E | F |
| Alcohol | Ethylene glycol | — | — | 55 | — | — | — |
| component | Adduct of | 18 | 18 | 5 | 18 | 23 | 13 |
| (mol) | bisphenol A | | | | | | |
| | with 1 mol of | | | | | | |
| | propylene oxide | | | | | | |
| | Adduct of | 102 | 102 | 60 | — | 107 | 97 |
| | bisphenol A | | | | | | |
| | with 1 mol of | | | | | | |
| | ethylene oxide | | | | | | |
| | Adduct of | — | — | — | 102 | — | — |
| | bisphenol A | | | | | | |
| | with 2 mol of | | | | | | |
| | ethylene oxide | | | | | | |
| Acid | Terephthalic | 100 | 105 | 100 | 100 | 100 | 100 |
| component | acid | | | | | | |
| (mol) | | | | | | | |
| Property | SP value | 11.3 | 11.4 | 11.6 | 10.4 | 11.27 | 11.38 |
| | Main peak | 4,500 | 5,500 | 4,500 | 4,500 | 3,000 | 6,500 |
| | of molecular | | | | | | |
| | weight | | | | | | |
| | distribution | | | | | | |
| | of THF | | | | | | |
| | solution portion | | | | | | |

### Example 1

### Manufacturing Example 1 of Mother Toner Particle

The amorphous polyester resin A at 76 percent by mass, hydrocarbon wax (Fisher-Tropsch wax, FNP-0090, SP value of 8.37, manufactured by NIPPON SEIRO CO., LTD.) at 6 percent by mass, styrene resin (FTR-2140, styrene-α-methyl styrene copolymer, SP value of manufactured by Mitsui Chemicals, Inc.) at 6 percent by mass, a colorant (carbon black #44, manufactured by Mitsubishi Chemical Corporation) at 11 percent by mass, and a charge control agent (azo iron compound, T-77, manufactured by HODOGAYA CHEMICAL CO., LTD.) at 1 percent by mass were mixed with a Henschel mixer (FM20B, manufactured by Mitsui Miike Chemical Engineering Machinery) followed by kneading at 120 degrees C. with a twin shaft kneader (PCM-30, manufactured by Ikegai Corp.). The kneaded matter obtained was rolled with a roller to a thickness of 2.7 mm and cooled down to room temperature with a belt cooler, followed by coarsely pulverizing the rolled kneaded matter to a size of 200 to 300 μm with a hammer mill. Next, the coarsely pulverized matter was finely pulverized with a supersonic pulverizer (LABO JET, manufactured by Nippon Pneumatic Mfg. Co., Ltd.). The finely-pulverized matter was then adjusted by classifying with an air-stream classifier (MDS-I, manufactured by Nippon Pneumatic Mfg. Co., Ltd.) to obtain mother toner particle 1 with a weight average particle diameter of 5.8±0.2 μm.

### Manufacturing of Toner

A total of 1.00 part by mass of metal oxide fine particle 1 (HDK-2000, manufactured by Clariant AG) was add to 100 parts by mass of the mother toner particle 1 followed by stirring and mixing with a Henschel mixer to obtain toner 1 to which the metal oxide fine particles were externally added.

### Manufacturing of Development Agent

The toner 1 at 5 percent by mass was uniformly mixed with a coating ferrite carrier at percent by mass with a turbular mixer (manufactured by Willy A. Bachofen AG (WBA) at 48 rpm for 5 minutes to obtain developing agent 1.

### Example 2

Toner 2 was obtained in the same manner as in Example 1 except that the proportion of FNP-0090 as hydrocarbon wax was changed to 7 percent by mass. Developing agent 2 was obtained in the same manner as in Example 1.

### Example 3

Toner 3 was obtained in the same manner as in Example 2 except that the proportion of the styrene resin (FTR-2140) was changed to a styrene resin (SX100, SP value of 9.9, manufactured by Yasuhara Chemical Co., Ltd.). Developing agent 3 was obtained in the same manner as in Example 2.

### Example 4

Toner 4 was obtained in the same manner as in Example 2 except that the amorphous polyester resin A was changed to the amorphous polyester resin B. Developing agent 4 was obtained in the same manner as in Example 2.

### Example 5

Toner 5 was obtained in the same manner as in Example 4 except that the styrene resin (FTR-2140) was changed to a styrene resin (SX100). Developing agent 5 was obtained in the same manner as in Example 4.

### Comparative Example 1

Toner 6 was obtained in the same manner as in Example 1 except that the amorphous polyester resin A was changed to the amorphous polyester resin C. Developing agent 6 was obtained in the same manner as in Example 1.

### Comparative Example 2

Toner 7 was obtained in the same manner as in Example 1 except that the hydrocarbon wax (FN-0090) was changed to carnauba wax (WA-05TS, SP value of 8.8, manufactured by TOAKASEI CO., LTD.). Developing agent 7 was obtained in the same manner as in Example 1.

### Comparative Example 3

Toner 8 was obtained in the same manner as in Example 1 except that the amorphous polyester resin A was changed to the amorphous polyester resin D. Developing agent 8 was obtained in the same manner as in Example 1.

### Comparative Example 4

Toner 9 was obtained in the same manner as in Example 1 except that the amorphous polyester resin A was changed to the amorphous polyester resin E. Developing agent 9 was obtained in the same manner as in Example 1.

### Comparative Example 5

Toner 10 was obtained in the same manner as in Example 1 except that the amorphous polyester resin A was changed to the amorphous polyester resin F. Developing agent 10 was obtained in the same manner as in Example 1.

### Comparative Example 6

Toner 11 was obtained in the same manner as in Example 1 except that the styrene resin (FTR-2140) was changed to the hydrogenated styrene resin (SP value of 9.0) below. Developing agent 11 was obtained in the same manner as in Example 1.

### Preparation Example of Hydrogenated Styrene Resin

A total of 100 g of styrene resin (SX-100), 3 g of a hydrogenating catalyst of palladium-barium sulfate, and 100 g of cyclohexane were placed in a 1 L autoclave. Thereafter, the system was heated to 250 degrees C. to conduct hydrogenating reaction at a hydrogen pressure of 10 Mpa for four hours. Thereafter, the solvent was removed at evaporation to obtain a hydrogenated styrene resin (SP value of 9.0).

### Comparative Example 7

Toner 12 was obtained in the same manner as in Example 1 except that the toner 12 was free of a styrene resin. Developing agent 12 was obtained in the same manner as in Example 1.

Each toner and each developing agent obtained were evaluated on filming resistance and hot offset resistance. The results are shown in Table 2.

### Filming Resistance

The developing agent was placed in the accommodating unit of a photocopier (RICOH MPC 6003, manufactured by Ricoh Co., Ltd.). The photocopier continuously formed a solid image with an amount of 0.4 mg/cm² of the developing agent on a printing media (Type 6200, manufactured by Ricoh Co., Ltd.) with a run length of 2,000 sheets. Thereafter, the latent electrostatic image bearer and the charger were visually checked to evaluate filming resistance based on the following evaluation criteria. The results are shown in Table 2.

### Evaluation Criteria

S: Free of contamination of latent electrostatic image bearer and free of filming on charger
A: Slight contamination on latent electrostatic image bearer and slight filming on charger
B: Slight contamination on latent electrostatic image bearer and slight filming on charger, causing defective images over time
C: Slight contamination on latent electrostatic image bearer and slight filming on charger, causing defective images in early occasion

### Hot Offset Resistance

The developing agent was placed in the accommodating unit of a photocopier (RICOH MPC 6003, manufactured by Ricoh Co., Ltd.). The photocopier continuously formed a solid image with an amount of 0.4 mg/cm² of the developing agent on a printing media (Type 6200, manufactured by Ricoh Co., Ltd.). The solid image was sequentially output at a linear fixing speed of 256 mm/s, a nipping width of the fixing device of 11 mm, and temperatures with 5 degrees C. apart to obtain the highest temperature (maximum fixing temperature: hot off resistance) below which hot offset did not occur. Hot offset was evaluated according to the following evaluation criteria. The results are shown in Table 2.

### Evaluation Criteria

A: Maximum fixing temperature is 200 degrees C. or higher
B: Maximum fixing temperature is from 180 to lower than 200 degrees C.
C: Maximum fixing temperature is lower than 180 degrees C.

TABLE 2

| | | Example | | | | | Comparative Example | | | | | | |
|---|---|---|---|---|---|---|---|---|---|---|---|---|---|
| | | 1 | 2 | 3 | 4 | 5 | 1 | 2 | 3 | 4 | 5 | 6 | 7 |
| Amorphous | A (SP value of | 76 | 75 | 75 | — | — | — | 76 | — | — | — | 76 | 82 |
| polyester | 11.3, main peak of | | | | | | | | | | | | |
| resin | molecular weight | | | | | | | | | | | | |
| | distribution of | | | | | | | | | | | | |
| | THF solution | | | | | | | | | | | | |
| | portion of 4,500) | | | | | | | | | | | | |
| | B (SP value of | — | — | — | 75 | 75 | — | — | — | — | — | — | — |
| | 11.4, main peak of | | | | | | | | | | | | |
| | molecular weight | | | | | | | | | | | | |
| | distribution of | | | | | | | | | | | | |
| | THF solution | | | | | | | | | | | | |
| | portion of 5,500) | | | | | | | | | | | | |
| | C (SP value of | — | — | — | — | — | 76 | — | — | — | — | — | — |
| | 11.6, main peak of | | | | | | | | | | | | |
| | molecular weight | | | | | | | | | | | | |
| | distribution of | | | | | | | | | | | | |
| | THF solution | | | | | | | | | | | | |
| | portion of 4,500) | | | | | | | | | | | | |
| | D (SP value of | — | — | — | — | — | — | — | 76 | — | — | — | — |
| | 10.4, main peak of | | | | | | | | | | | | |
| | molecular weight | | | | | | | | | | | | |
| | distribution of | | | | | | | | | | | | |
| | THF solution | | | | | | | | | | | | |
| | portion of 4,500) | | | | | | | | | | | | |
| | E (SP value of | — | — | — | — | — | — | — | — | 76 | — | — | — |
| | 11.27, main peak of | | | | | | | | | | | | |
| | molecular weight | | | | | | | | | | | | |
| | distribution of | | | | | | | | | | | | |
| | THF solution | | | | | | | | | | | | |
| | portion of 3,000) | | | | | | | | | | | | |
| | F (SP value of | — | — | — | — | — | — | — | — | — | 76 | — | — |
| | 11.38, main peak of | | | | | | | | | | | | |
| | molecular weight | | | | | | | | | | | | |
| | distribution of | | | | | | | | | | | | |
| | THF solution | | | | | | | | | | | | |
| | portion of 6,500) | | | | | | | | | | | | |
| Wax | Fisher-Tropsch wax | 6 | 7 | 7 | 7 | 7 | 6 | — | 6 | 6 | 6 | 6 | 6 |
| | (FNP-0090, SP | | | | | | | | | | | | |
| | value of 8.37) | | | | | | | | | | | | |
| | Carnauba wax | — | — | — | — | — | — | 6 | — | — | — | — | — |
| | (WA-05TS, SP | | | | | | | | | | | | |
| | value of 8.8) | | | | | | | | | | | | |
| Styrene | Styrene-α- | 6 | 6 | — | 6 | — | 6 | 6 | 6 | 6 | 6 | — | — |
| resin | methylstyrene | | | | | | | | | | | | |
| | copolymer | | | | | | | | | | | | |
| | (FTR-2140, SP | | | | | | | | | | | | |
| | value of 10.3) | | | | | | | | | | | | |
| | Styrene resin | — | — | 6 | — | 6 | — | — | — | — | — | — | — |
| | (SX100, SP | | | | | | | | | | | | |
| | value of 9.9) | | | | | | | | | | | | |
| | Styrene resin | — | — | — | — | — | — | — | — | — | — | 6 | — |
| | (hydrogenated | | | | | | | | | | | | |
| | styrene resin, SP | | | | | | | | | | | | |
| | value of 9.0) | | | | | | | | | | | | |
| Pigment | Carbon black (#44, | 11 | 11 | 11 | 11 | 11 | 11 | 11 | 11 | 11 | 11 | 11 | 11 |
| | manufactured by | | | | | | | | | | | | |
| | Mitsui Chemicals, | | | | | | | | | | | | |
| | Inc.) | | | | | | | | | | | | |
| Charge | Azo-iron | 1 | 1 | 1 | 1 | 1 | 1 | 1 | 1 | 1 | 1 | 1 | 1 |
| control | compound (T-77, | | | | | | | | | | | | |
| agent | manufactured by | | | | | | | | | | | | |
| | HODOGAYA | | | | | | | | | | | | |
| | CHEMICAL | | | | | | | | | | | | |
| | CO., LTD.) | | | | | | | | | | | | |
| Evaluation | Filming | S | B | A | B | A | C | S | C | A | C | C | C |
| result | resistance | | | | | | | | | | | | |
| | Hot offset | S | S | B | S | B | S | C | A | C | A | A | A |
| | resistance | | | | | | | | | | | | |

The aspects of the present disclosure are, for example, as follows:
1. A toner contains an amorphous polyester resin with an SP value of from 11.0 to 11.5 (cal/cm³)^{1/2}; a styrene resin with an SP value of from 9.5 to 10.5 cal/cm³)^{1/2}, and a hydrocarbon wax, wherein the molecular weight distribution of the toner soluble in tetrahydrofuran has a main peak between 3,500 to 5,500 as measured by gel permeation chromatography.
2. The toner according to the 1 mentioned above, wherein the molecular weight distribution has the main peak between 4,000 to 4,500.
3. The toner according to the 1 or 2 mentioned above, wherein the hydrocarbon wax contains Fisher-Tropsch wax.
4. The toner according to the 1 or 2 mentioned above, wherein the proportion of the hydrocarbon wax to the toner is from 2 to 6 percent by mass.
5. The toner according to any one of the 1 to 4 mentioned above, wherein the hydrocarbon wax has an SP value of from 8.0 to 9.0.
6. The toner according to any one of the 1 to 5 mentioned above, wherein the styrene resin contains styrene-α-methyl styrene.
7. A developing agent contains the toner of any one of the 1 to 6 mentioned above.
8. A toner accommodating unit includes the toner of any one of the 1 to 6 mentioned above.
9. An image forming apparatus includes a latent electrostatic image bearer, a latent electrostatic image forming device for forming a latent electrostatic image on the latent electrostatic image bearer, a developing device for developing the latent electrostatic image with a developing agent containing the toner of any one of the 1 to 6 mentioned above to form a visible image, a transfer device for transferring the visible image to a printing medium and a fixing device for fixing the visible image transferred onto the printing medium.
10. An image forming method includes forming a latent electrostatic image on a latent electrostatic image bearer, developing the latent electrostatic image formed on the latent electrostatic image bearer with a developing agent containing the toner of any one of the 1 or 6 mentioned above to form a visible image, transferring the visible image to a printing medium, and fixing the visible image on the printing medium.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A toner comprising:
an amorphous polyester resin with an SP value of from 11.0 to 11.5 (cal/cm³)^{1/2};
a styrene resin with an SP value of from 9.5 to 10.5 (cal/cm³)^{1/2}; and
a hydrocarbon wax,
wherein a molecular weight distribution of the toner soluble in tetrahydrofuran has a main peak between 3,500 to 5,500 as measured by gel permeation chromatography.

2. The toner according to claim 1, wherein the molecular weight distribution has the main peak between 4,000 to 4,500.

3. The toner according to claim 1, wherein the hydrocarbon wax comprises Fisher-Tropsch wax.

4. The toner according to claim 1, wherein a proportion of the hydrocarbon wax to the toner is from 2 to 8 percent by mass.

5. The toner according to claim 1, wherein the hydrocarbon wax has an SP value of from 8.0 to 9.0 (cal/cm³)^{1/2}.

6. The toner according to claim 1, wherein the styrene resin comprises styrene-α-methylstyrene.

7. A developing agent comprising:
the toner of claim 1.

8. A toner accommodating unit containing the toner of claim 1.

9. An image forming apparatus comprising:
a latent electrostatic image bearer;
a latent electrostatic image forming device configured to form a latent electrostatic image on the latent electrostatic image bearer;
a developing device configured to develop the latent electrostatic image with a developing agent comprising the toner of claim 1 to form a visible image;
a transfer device configured to transfer the visible image to a printing medium; and
a fixing device configured to fix the visible image transferred onto the printing medium.

10. An image forming method comprising:
forming a latent electrostatic image on a latent electrostatic image bearer;
developing the latent electrostatic image formed on the latent electrostatic image bearer with a developing agent comprising the toner of claim 1 to form a visible image;
transferring the visible image to a printing medium; and
fixing the visible image on the printing medium.
